(19) United States
(12) Patent Application Publication
(10) Pub. No.: US 2023/0365786 A1
(43) Pub. Date: Nov. 16, 2023

(54) METHOD FOR PREPARING SILICON OXIDE POWDER FILLER, POWDER FILLER OBTAINED THEREBY, AND APPLICATION OF SILICON OXIDE POWDER FILLER

(71) Applicant: ZHEJIANG THIRD AGE MATERIAL TECHNOLOGY CO., LTD, Huzhou (CN)

(72) Inventors: Wen LI, Huzhou (CN); Jiangbo HUANG, Huzhou (CN); Ke WANG, Huzhou (CN); Dawei ZHANG, Huzhou (CN)

(21) Appl. No.: 18/270,445

(22) PCT Filed: Oct. 28, 2021
(86) PCT No.: PCT/CN2021/127075

§ 371 Date: Jun. 29, 2023

(30) Foreign Application Priority Data
Dec. 31, 2020 (CN) 202011633776.9

(51) Int. Cl. C08K 9/06; C08G 77/398; B01J 6/00; C08K 3/22; C08K 3/36

(52) U.S. Cl. CPC C08K 9/06; C08G 77/398; B01J 6/001; C08K 3/22; C08K 3/36; C08K 2003/2237; C08K 2201/005

(57) ABSTRACT

A method for preparing a silicon oxide powder filler is disclosed. The method may include providing a polysiloxane powder by dispersing a high-dielectric-constant powder in an aqueous solution and adding R₁SiX₃ to the aqueous solution for a hydrolysis condensation reaction, the polysiloxane powder being polysiloxane containing the high-dielectric-constant powder and comprising a T unit, and a particle size of the high-dielectric-constant powder being less than that of the polysiloxane. The method may further include calcining the polysiloxane powder in an oxygen-containing atmosphere, where the calcining temperature may be between 850 degrees and 1200 degrees, to obtain a silicon oxide powder filler containing the high-dielectric-constant powder inside.

### BACKGROUND OF THE INVENTION

### Field of the Invention

The present invention relates to circuit boards and packaged antennas, and more particularly to a method for preparing a silicon oxide powder filler, powder filler obtained thereby and application thereof.

### Related Art

In the field of 5G communication, equipments assembled by the radio frequency devices and circuit boards such as high-density interconnect boards (HDI), high-frequency high-speed boards and motherboards, etc. are required. These circuit boards are generally composed of fillers and organic polymers such as epoxy resin, aromatic polyether and fluororesin, etc. The fillers are mainly angular or spherical silicon oxide whose main function is to reduce the thermal expansion coefficient of organic polymers. The spherical or angular silicon oxide is tightly packed and graded in the existing fillers.

As technology advances, communication devices are getting smaller and smaller. Antennas, which are indispensable in communication devices, are also getting smaller and smaller, thus packaged antenna AIPs will be used eventually. Due to the design, the substrates and packaging materials used for making a small-size antennas must have high dielectric constant and low dielectric loss. However, the existing known packing materials cannot satisfy the requirements.

### SUMMARY OF THE INVENTION

In order to solve the problem that the dielectric constant of the existing known packing materials in the prior art cannot satisfy the requirements of a small-size communication device, the present invention provides a method for preparing a silicon oxide powder filler, powder filler obtained thereby and application thereof.

The present invention provides a method for preparing a silicon oxide powder filler, comprising the following steps: S1, providing a polysiloxane powder by dispersing a high-dielectric-constant powder in an aqueous solution and adding R₁SiX₃ to the aqueous solution for a hydrolysis condensation reaction, the polysiloxane powder being polysiloxane containing the high-dielectric-constant powder and comprising a T unit, wherein R₁ is hydrogen atom or an organic group having independently selectable 1 to 18 carbon atoms, X is a hydrolyzable group, and T unit is R₁SiO₃-, and wherein a particle size of the high-dielectric-constant powder is less than that of the polysiloxane; and S2, calcining the polysiloxane powder in an oxygen-containing atmosphere, the calcining temperature being between 850 degrees and 1200 degrees, to obtain a silicon oxide powder filler containing the high-dielectric-constant powder inside.

Preferably, the particle size of the high-dielectric-constant powder □ one-third of the particle size of polysiloxane.

Preferably, R₁SiX₃ is a methyltrimethoxysilane.

Preferably, the high-dielectric-constant powder is selected from at least one of titanium oxide, zinc oxide, zirconia, titanate, zincate and zirconate. In a preferred embodiment, the high-dielectric-constant powder is barium titanate, titanium oxide or calcium titanate.

Preferably, the aqueous solution in step S1 is a solution whose main component is water. Preferably, the weight percentage of water in the aqueous solution is between 80% and 100%. In a preferred embodiment, the aqueous solution is deionized water.

Preferably, the calcining temperature is between 850 degrees and 1100 degrees, and the calcining time is between 6 hours and 12 hours.

Preferably, the polysiloxane further comprises a Q unit, a D unit, and/or a M unit, wherein Q unit is SiO₄-, D unit is R₂R₃SiO₂-, M unit is R₄R₅R₆SiO-, wherein each of R₂, R₃, R₄, R₅, R₆ is a hydrogen atom or a hydrocarbon group having independently selectable 1 to 18 carbon atoms.

Preferably, a raw material R₁SiX₃ of T unit of polysiloxane is selected from at least one of methyltrimethoxysilane, hydrocarbonyl-trihydrocarbonoxysilane, methyltrichlorosilane and hydrocarbonyl-trichlorosilane; a raw material of Q unit is selected from at least one of tetrahydrocarbonoxysilane, silicon tetrachloride and silicon oxide; a raw material of D unit is selected from at least one of dihydrocarbonyl-dihydrocarbonoxysilane and dihydrocarbonyl-dichlorosilane; and a raw material of M unit is selected from at least one of trihydrocarbonyl-hydrocarbonoxysilane, trihydrocarbonyl-chlorosilane and hexahydrocarbonyl-disilazane. In a preferred embodiment, the R₁SiX₃ silane is methyltrimethoxysilane, the raw material of Q unit is tetraethoxysilane, the raw material of D unit is dimethyldichlorosilane.

Preferably, polysiloxane is spherical or angular polysiloxane.

Preferably, the preparation method further comprises adding a treatment agent to perform surface treatment on the silicon oxide powder filler, and the treatment agent comprises a silane coupling agent and/or disilazane; the silane coupling agent is (R₇)ₐ(R₈)_{b}Si(M)_{4-a-b}, wherein each of R₇, R₈ is a hydrogen atom, a hydrocarbon group having independently selectable 1 to 18 carbon atoms, or a hydrocarbon group having independently selectable 1 to 18 carbon atoms replaced by a functional group, wherein the functional group is selected from at least one of vinyl, allyl, styryl, epoxy group, aliphatic amino, aromatic amino, methacryloxypropyl, acryloyloxypropyl, ureidopropyl, chloropropyl, mercaptopropyl, polysulfide group, isocyanate propyl; M is an alkoxy group with 1 to 18 carbon atoms or a halogen atom, a is 0, 1, 2 or 3, b is 0, 1, 2 or 3, a+b is 1,2 or 3; the disilazane is (R₉R₁₀R₁₁)SiNHSi(R₁₂R₁₃R₁₄), wherein each of R₉, R₁₀, R₁₁, R₁₂, R₁₃, R₁₄ is a hydrogen atom or a hydrocarbon group having independently selectable 1 to 18 carbon atoms.

The present invention also provides a silicon oxide powder filler prepared by the above-mentioned method, wherein the high-dielectric-constant powder is included inside the silicon oxide powder filler.

Preferably, the volume fraction of the high-dielectric-constant powder in the polysiloxane powder is between 5% and 95%, and the average particle size of the silicon oxide powder filler is between 0.5 microns and 50 microns. In preferred embodiments, the volume fraction of the high-dielectric-constant powder in the polysiloxane powder is between 10% and 60%, and the average particle size of the silicon oxide powder filler is between 1.2 microns and 5.8 microns.

The present invention also provides an application of the silicon oxide powder filler, wherein the silicon oxide powder filler of different particle sizes is tightly packed and graded in resin to form a composite material, which is suitable for circuit board material and semiconductor packaging material.

Preferably, coarse particles above 1 μm, 3 μm, 5 μm, 10 μm, or 20 μm in the silicon oxide powder filler are removed by a dry or wet sieving or inertial classification.

By means of the method for preparing a silicon oxide powder filler in the present invention, the silicon oxide powder filler containing the high-dielectric-constant powder inside can be obtained, and the filler has a high dielectric constant by means of the high-dielectric-constant powder contained therein, thereby satisfying the requirements of a small-size communication device. In particular, although the high-dielectric-constant powder has high surface activity property and cannot couple the silane coupling agent, since the high-dielectric-constant powder is included inside the silicon oxide, the high-dielectric-constant powder will not affect the affinity of the silicon oxide powder filler with the resin, satisfying the requirements of circuit board and antenna packaging.

### BRIEF DESCRIPTION OF THE DRAWINGS

FIG. 1 is a schematic diagram of the silicon oxide powder filler according to Embodiment 1 of the present invention.

FIG. 2 is a schematic diagram of the silicon oxide powder filler according to Embodiment 2 of the present invention.

FIG. 3 is a schematic diagram of the silicon oxide powder filler according to Embodiment 3 of the present invention.

### DESCRIPTION OF THE ENABLING EMBODIMENT

In conjunction with the accompanying drawings, preferred embodiments of the present invention are given and described in detail below.

The detection methods involved in the following embodiments are listed as follows.

The average particle size is measured with HORIBA's laser particle size distribution analyzer LA-700.

The geometry of the powder is observed by an electron microscopy (EM) and determined by an EDX elemental analysis. Specifically, the powder and epoxy resin are mixed and cured. The surface of the solidified product is polished after sectioning, and the polished particle section is observed by the EM, and the composition of different fields is determined by the EDX element analysis. The results are characterized by schematic diagrams.

The volume fraction of the high-dielectric-constant powder in polysiloxane powder=(a weight of the high-dielectric-constant powder/a specific gravity of the high-dielectric-constant powder)/(a weight of the high-dielectric-constant powder/a specific gravity of the high-dielectric-constant powder+a weight of polysiloxane/a specific gravity of polysiloxane). The specific gravity of polymethylsiloxane (also known as polymethylsilsesquioxane) is 1.34.

In this text, the average particle size refers to the volume average diameter of the particles.

Embodiment 1

Deionized water of a certain weight at room temperature was added into a reactor with a stirrer. A commercially available barium titanate with an average particle size of 0.3 microns was dispersed in the water. While stirring, methyltrimethoxysilane of 80 by weight was added to stir for 1 hour. After the methyltrimethoxysilane was dissolved, 5% ammonia water of 25 by weight was added and stirred for 10 seconds, and then the stirring was stopped. After standing for 1 hour, it was filtered and dried to obtain spherical powder. The powder was put into a muffle furnace to slowly heat up in an oxygen-containing atmosphere to discharge the organic matter. The final calcining temperature was 10 00 degrees, i.e., ° C., and the calcining time was 6 hours. The spherical barium titanate-containing silicon oxide powder was finally obtained. The analysis results of the samples were listed in following Table 1.

TABLE 1

| | Deionized | Average | Barium Titanate |
|---|---|---|---|
| | Water by | Particle Size | Volume |
| | Weight | (μm) | Fraction (%) |
| Example 1 | 1100 | 1.2 | 10 |
| Example 2 | 800 | 4.0 | 40 |
| Example 3 | 600 | 5.8 | 60 |

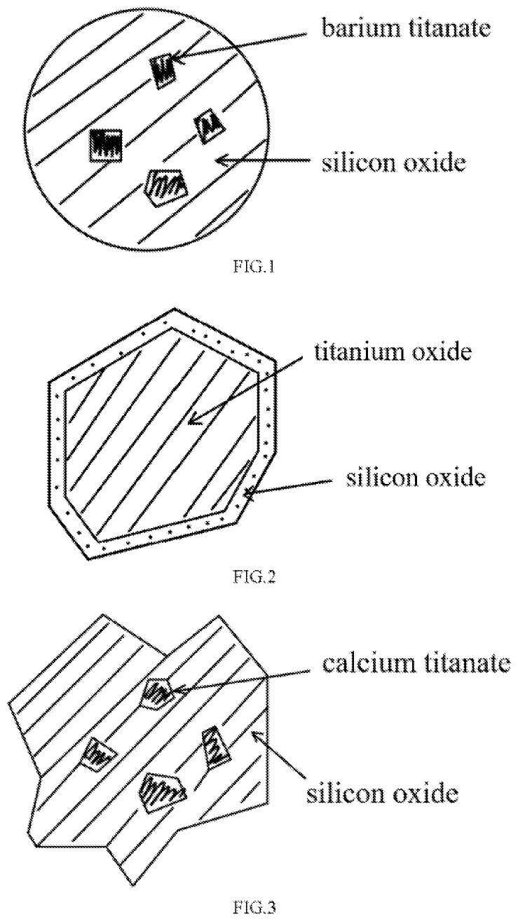

The samples of Examples 1-3 were analyzed by EM and EDX. As shown in FIG. 1, the barium titanate was included inside the silicon oxide.

Embodiment 2

Deionized water of a certain weight at room temperature was added into a reactor with a stirrer. A commercially available titanium oxide with an average particle size of 0.38 microns was dispersed in the water. While stirring, methyltrimethoxysilane of 75 by weight and tetraethoxysilane of 5 by weight was added to stir for 1 hour. After the methyltrimethoxysilane and tetraethoxysilane was dissolved, 5% ammonia water of 25 by weight was added and stirred for 10 seconds, and then the stirring was stopped. After standing for 1 hour, it was filtered and dried to obtain powder. The powder was put into a muffle furnace to slowly heat up in an oxygen-containing atmosphere to discharge the organic matter. The final calcining temperature was 850 degrees, i.e., ° C., and the calcining time was 12 hours. The titanium oxide-containing silicon oxide powder was finally obtained. The analysis result of the sample was listed in following Table 2.

TABLE 2

| | Deionized | Average | Titanium Oxide |
|---|---|---|---|
| | Water by | Particle Size | Volume |
| | Weight | (μm) | Fraction (%) |
| Example 4 | 1500 | 0.9 | 80 |

The sample of Example 4 was analyzed by EM and EDX. As shown in FIG. 2, the titanium oxide was included inside the silicon oxide.

Embodiment 3

Deionized water of a certain weight at room temperature was added into a reactor with a stirrer. A commercially available calcium titanate with an average particle size of 2 microns was dispersed in the water. While stirring, methyltrichlorosilane of 78 by weight and dimethyldichlorosilane of 2 by weight was added to stir for 1 hour. The volume fraction of calcium titanate was 30%. After filtered, washed and dried, a white solid was obtained. The white solid was crushed with a pulverizer to obtain an angular powder with an average particle size of 50. The powder was put into a muffle furnace to slowly heat up in an oxygen-containing atmosphere to discharge the organic matter. The final calcining temperature was 1000 degrees, i.e., ° C., and the calcining time was 12 hours. The calcium titanate-containing angular silicon oxide powder was finally obtained. The average particle size of the sample is 42 microns. The sample of Example 5 was analyzed by EM and EDX. The structure of the sample of Example 5 was shown in FIG. 3.

It should be understood that the samples obtained in the Examples 1-5 may be surface-treated. Specifically, vinyl silane coupling agent, epoxy silane coupling, disilazane, etc. can be used to treat the samples as required. Also, at least two treatment agents can be used to treat the samples as required.

It should be understood that coarse particles above 1 μm, 3 μm, 5 μm, 10 μm, or 20 μm in the filler can be removed by a dry or wet sieving or inertial classification.

It should be understood that the silicon oxide powder filler of different particle sizes is tightly packed and graded in resin to form a composite material.

The foregoing description refers to preferred embodiments of the present invention and is not intended to limit the scope of the present invention. Various changes can be made to the foregoing embodiments of the present invention. That is to say, all simple and equivalent changes and modifications made in accordance with the claims of the present invention and the content of the description fall into the protection scope of the patent of the present invention. What is not described in detail in the present invention is conventional technical content.

1. A method for preparing a silicon oxide powder filler, comprising:
S1, providing a polysiloxane powder by dispersing a high-dielectric-constant powder in an aqueous solution and adding R₁SiX₃ to the aqueous solution for a hydrolysis condensation reaction, the polysiloxane powder being polysiloxane containing the high-dielectric-constant powder and comprising a T unit, wherein R₁ is hydrogen atom or an organic group having independently selectable 1 to 18 carbon atoms, X is a hydrolyzable group, and T unit is R₁SiO₃-, and wherein a particle size of the high-dielectric-constant powder is less than that of the polysiloxane; and
S2, calcining the polysiloxane powder in an oxygen-containing atmosphere, using a calcining temperature being between 850 degrees and 1200 degrees, to obtain a silicon oxide powder filler containing the high-dielectric-constant powder inside.

2. The method of claim 1, wherein the particle size of the high-dielectric-constant powder is less than or equal to one-third of the particle size of polysiloxane.

3. The method of claim 1, wherein the high-dielectric-constant powder is selected from at least one of titanium oxide, zinc oxide, zirconia, titanate, zincate and zirconate.

4. The method of claim 1, wherein the calcining temperature is between 850 degrees and 1100 degrees, and further comprising calcinating the polysiloxane powder using a calcining time is between 6 hours and 12 hours.

5. The method of claim 1, wherein the polysiloxane further comprises a Q unit, a D unit, and/or a M unit, wherein Q unit is SiO₄-, D unit is R₂R₃SiO₂-, M unit is R₄R₅R₆SiO-, wherein each of R₂, R₃, R₄, R₅, R₆ is a hydrogen atom or a hydrocarbon group having independently selectable 1 to 18 carbon atoms.

6. The method of claim 5, wherein a raw material R₁SiX₃ of T unit of polysiloxane is selected from at least one of methyltrimethoxysilane, hydrocarbonyl-trihydrocarbonoxysilane, methyltrichlorosilane and hydrocarbonyl-trichlorosilane; a raw material of Q unit is selected from at least one of tetrahydrocarbonoxysilane, silicon tetrachloride and silicon oxide; a raw material of D unit is selected from at least one of dihydrocarbonyl-dihydrocarbonoxysilane and dihydrocarbonyl-dichlorosilane; and a raw material of M unit is selected from at least one of trihydrocarbonyl-hydrocarbonoxysilane, trihydrocarbonyl-chlorosilane and hexahydrocarbonyl-disilazane.

7. The method of claim 1, wherein the method further comprises adding a treatment agent to perform surface treatment on the silicon oxide powder filler, and the treatment agent comprises a silane coupling agent and/or disilazane; the silane coupling agent is (R₇)ₐ(R₈)_{b}Si(M)_{4-a-b}, wherein each of R₇, R₈ is a hydrogen atom, a hydrocarbon group having independently selectable 1 to 18 carbon atoms, or a hydrocarbon group having independently selectable 1 to 18 carbon atoms replaced by a functional group, wherein the functional group is selected from at least one of vinyl, allyl, styryl, epoxy group, aliphatic amino, aromatic amino, methacryloxypropyl, acryloyloxypropyl, ureidopropyl, chloropropyl, mercaptopropyl, polysulfide group, isocyanate propyl; M is an alkoxy group with 1 to 18 carbon atoms or a halogen atom, a is 0, 1, 2 or 3, b is 0, 1, 2 or 3, a+b is 1, 2 or 3; the disilazane is (R₉R₁₀R₁₁)SiNHSi(R₁₂R₁₃R₁₄), wherein each of R₉, R₁₀, R₁₁, R₁₂, R₁₃, R₁₄ is a hydrogen atom or a hydrocarbon group having independently selectable 1 to 18 carbon atoms.

8. The method of claim 1, wherein the high-dielectric-constant powder is included inside the silicon oxide powder filler.

9. The method of claim 1, wherein an volume fraction of the high-dielectric-constant powder in the polysiloxane powder is between 5% and 95%, and an average particle size of the silicon oxide powder filler is between 0.5 microns and 50 microns.

10. The method of claim 1, wherein the silicon oxide powder filler of different particle sizes is tightly packed and graded in resin to form a composite material, which is suitable for circuit board material and semiconductor packaging material.

11. The method of claim 9, wherein coarse particles above 1 μm, 3 μm, 5 μm, 10 μm, or 20 μm in the silicon oxide powder filler are removed by a dry or wet sieving or inertial classification.
